(19) United States
(12) Patent Application Publication
(10) Pub. No.: US 2010/0191998 A1
(43) Pub. Date: Jul. 29, 2010

(54) APPORTIONING AND REDUCING DATA CENTER ENVIRONMENTAL IMPACTS, INCLUDING A CARBON FOOTPRINT

(75) Inventor: George M. Moore, Bellevue, WA (US)

Correspondence Address: SHOOK, HARDY & BACON L.L.P.;(MICROSOFT CORPORATION), INTELLECTUAL PROPERTY DEPARTMENT, 2555 GRAND BOULEVARD, KANSAS CITY, MO, 64108-2613, US

(73) Assignee: Microsoft Corporation, Redmond, WA (US)

(21) Appl. No.: 12/358,974

(22) Filed: Jan. 23, 2009

(51) Int. Cl. G06F 1/26

(52) U.S. Cl. 713/340

(57) ABSTRACT

Determining and apportioning the environmental impacts of a data center provides useful business intelligence for data center consumers. In one embodiment, apportioned carbon footprints are determined by identifying a data center and an application, determining the carbon footprint of a data center, and apportioning the carbon footprint on an application-specific basis. Apportioned carbon footprints are then selectively utilized as disclosed, such as, for example, to selectively adjust data center load. Other embodiments include different environmental impacts, including water consumption.

### BACKGROUND

Digital information management has now essentially replaced old, paper-based methods of information management. In comparison with more traditional methods of information management, digital information management is generally regarded as less expensive, less bulky, more reliable, and more secure. As such, in order to meet present and future computing needs, many commercial, academic, and governmental institutions are demanding increasingly sophisticated and energy intensive computing resources. In response to this demand, current investments in modern data and communications infrastructure are rapidly increasing, especially for the life-blood of this modern digital movement: the data center.

In general, a data center is a large facility that houses various computer systems and related components, such as, for example, microcomputers (i.e., servers), switches, uninterruptible power supplies (UPS), redundant systems, environmental controls, and the like. As a result of these various components, data centers play a vital role in providing resources necessary to power our modern methods of information management.

However, this trend towards complete digital information management has not come without cost. On the contrary, data centers and the computing resources they require are energy and resource intensive. For example, the United States Environmental Protection Agency estimated that in 2006 approximately 61 billion kilowatt-hours (kWh) of electricity was consumed to power our national data centers. As such, nearly 2% of all electricity consumed in the United States during 2006 went to power domestic data centers. Fueled by consumer demand, data center energy consumption is projected to nearly double within a few years and exceed 100 billion kWh of total electricity by 2011. As a majority of U.S. electricity is generated by carbon-based fuel sources that emit various greenhouse gases during the energy production process, potential environmental impacts associated with increased electricity consumption are garnering much attention from private and public institutions. Further, data center water usage also represents a non-trivial industry concern. For example, a one megawatt data center can use approximately 18,000 gallons per day to dissipate heat generated during operation of the data center. Just like electricity generation, water supply represents a limited natural resource that can substantially affect the overall environmental impacts of a data center.

Due to a conflicting need to employ increasingly resource-intensive computing devices and a desire to minimize overall environmental impacts, many modern institutions find themselves in a troubling situation.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Embodiments of the present invention relate to, among other things, calculating and apportioning an environmental impact associated with the operation of a data center. One or more data centers are identified and the environmental impacts attributable to the data centers are determined. By way of example and not limitation, the carbon dioxide emissions can be and are apportioned on the basis of a data center application. Accordingly, the present invention permits apportioning an environmental impact on a per application basis.

### BRIEF DESCRIPTION OF THE DRAWINGS

The present invention is described in detail below with reference to the attached drawing figures, wherein:

FIG. 1 is a block diagram of an exemplary computing environment suitable for use in implementing embodiments of the present invention;

FIG. 2 is a block diagram of an exemplary system in which embodiments of the present invention may be implemented;

FIG. 3 is a flow diagram showing a method for calculating an environmental impact of a data center in accordance with an embodiment of the present invention;

FIG. 4 is a flow diagram showing a method for apportioning a carbon footprint of a data center in accordance with an embodiment of the present invention;

FIG. 5 is a flow diagram showing a method of comparing the relative carbon footprint of multiple data centers in accordance with an embodiment of the present invention;

FIG. 6 is a flow diagram showing a method of selectively utilizing data center resources in response to expected carbon emissions in accordance with an embodiment of the present invention; and

FIG. 7 is a chart showing one potential comparison in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### Overview

Embodiments of the present invention provide a method for apportioning the carbon footprint and/or water usage of a data center on an application-specific basis. By way of example only and not limitation, the carbon dioxide emissions or water usage associated with consuming one data center application, for example, using an amount of storage at a data center, can be isolated and apportioned.

Data center consumers vary widely in sophistication, demand, and geography. Accordingly, our national data and communications network consists of an integrated, yet individually unique, system of data centers. Given the varying age of each data center, the varying geography, or the varying power grid surrounding this system of data centers, each data center has unique properties of electrical consumption, water usage, and/or environmental impact.

Accordingly, in one aspect, an embodiment of the present invention is directed to one or more computer-readable storage media embodying computer useable instructions for performing a method of apportioning an environmental impact of a data center. The method includes identifying at least one data center and an application. The application is selected from a group consisting of a server, a virtual machine, an amount of storage, and an amount of bandwidth. The method also includes calculating a total amount of electricity consumed by the at least one data center. The method further includes calculating an environmental impact at least one data center. The method also includes determining an apportioned amount of the environmental impact per the application

In another embodiment of the invention, an aspect is directed to a method of assessing relative carbon dioxide usage at a data center. The method includes identifying a first plurality of data centers, a second plurality data centers, and an application, wherein the first plurality of data centers are commonly owned or commonly operated. The method also includes calculating a first total amount of electricity consumed at the first plurality data centers and a second total amount of electricity at the second plurality data centers. The method still also includes calculating a first total amount of carbon dioxide emitted as a result of generation of the first total amount of electricity at the first plurality of data centers and calculating a second total amount of carbon dioxide emitted as a result of generation of the second total amount of electricity consumed at the second plurality data centers, wherein calculating the second total amount of carbon dioxide emitted as a result of generation of the second total amount of electricity consumed at the second plurality data centers comprises utilizing national, regional or industry averages representative of carbon dioxide emissions per unit of electricity consumed. The method further includes determining a first apportioned amount of carbon dioxide emitted as a result of generation of the first total amount of electricity consumed at the first plurality of data centers per the application. The method further includes determining a second apportioned amount of carbon dioxide emitted as a result of generation of the first total amount of electricity at the second plurality of data centers per the application. The method still further includes comparing the first apportioned amount of carbon dioxide emitted to the second apportioned amount of carbon dioxide emitted.

A further embodiment of the present invention is directed to one or more computer-readable storage media embodying computer useable instructions for performing a method of prospectively minimizing data center-related carbon dioxide emissions. The method first includes identifying a first data center. The method also includes identifying a second data center. The method still also includes identifying an application. The method further includes calculating an expected first amount of electricity consumption at the first data center. The method still further includes calculating an expected second amount of electricity consumption at the second data center. The method further includes calculating an expected first amount of carbon dioxide emitted as a result of the generation of the expected first amount of electricity consumption. The method still further includes calculating an expected second amount of carbon dioxide emitted as a result of the generation of the expected second amount of electricity consumption. The method also includes determining an expected first apportioned amount of the expected first amount of carbon dioxide. The method further includes determining an expected second apportioned amount of the expected second amount of carbon dioxide. The method still further includes comparing the expected first apportioned amount to the expected second apportioned amount. The method also includes determining whether the expected first apportioned amount or the expected second apportioned amount has a lower expected amount of carbon dioxide emission. The method also includes selectively utilizing the application at a data center determined to have the lower expected amount of carbon dioxide emitted.

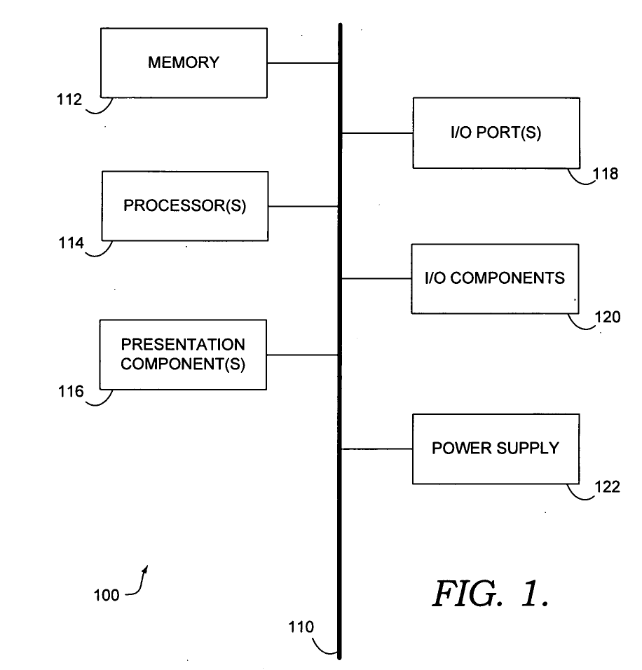

Having briefly described an overview of embodiments of the present invention, an exemplary operating environment in which embodiments of the present invention may be implemented is described below in order to provide a general context for various aspects of the present invention. Referring initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more presentation components 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. We recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

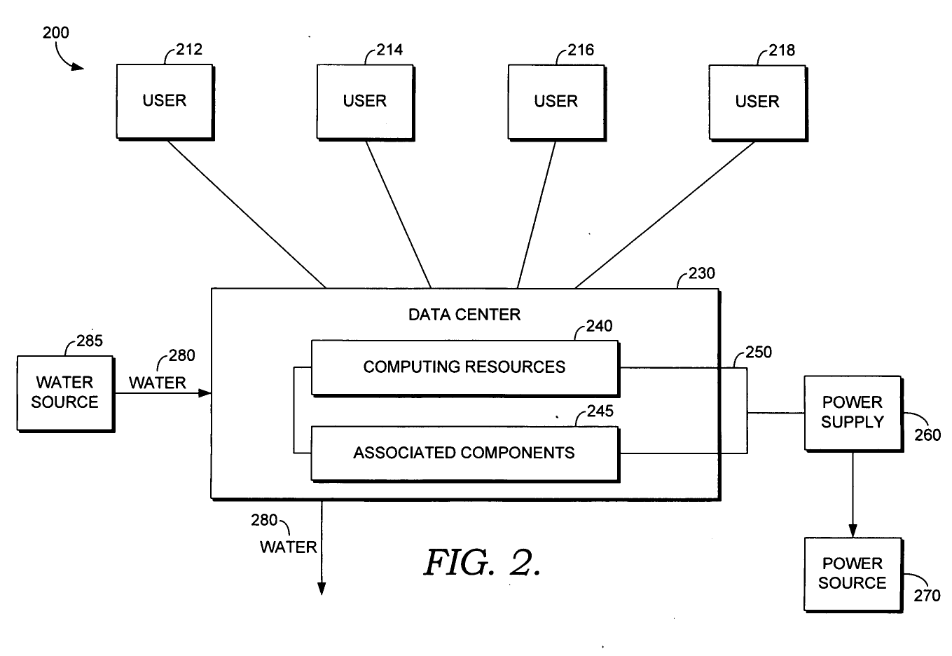

Turning to FIG. 2, a block diagram is illustrated that shows a simplified data center system 200 suitable for practicing embodiments of the present invention of apportioning carbon dioxide usage at a data center. It will be understood and appreciated by those of ordinary skill in the art that the overall data center system 200 shown in FIG. 2 is merely an example of one suitable environment and is not intended to suggest any limitation as to the scope or functionality of the present invention.

Data center system 200 includes a plurality of users 210, 212, 214, and 216 in communication with a data center 230 having computing resources 240 and associated components 245. In this exemplary system, four users 210, 212, 214, and 216 are shown. It will be understood by those of ordinary skill in the art that such is merely exemplary and that the system 200 may include any number of users in communication with data center 230. Each of the plurality of users 210, 212, 214, and 216 shown in FIG. 2 may utilize any type of computing device, such as, for example, computing device 100 described above with reference to FIG. 1. By way of example only and not limitation, each of the plurality of users 210, 212, 214, and 216 may utilize, to communicate with data center 230, a server, a computer, a handheld device, a consumer electronic device, or the like. Further, each of the plurality of users 210, 212, 214, and 216 may communicate with data center 230 via a collection of servers, computers, handheld devices, or consumer electronic devices, or the like, that form a computer network or a collection of computer networks.

In FIG. 2, the plurality of users 210, 212, 214, and 216 utilize computing resources 240 of data center 230 to run applications 220, 222, 224, and 226. As herein used, the term application means any service or product that requires the consumption of electricity generally offered for sale by a data center. Intended applications most suitable for the present invention include servers, virtual machines, storage, and bandwidth. As such, each of the applications 220, 222, 224, and 226 shown in FIG. 2 may be any type of application mentioned above. As a result of running applications 220, 222, 224, and 226 on computing resources 240, data center 230 requires electricity 250 from power supply 260. Moreover, data center 230 requires electricity 250 from power supply 260 to power all associated components 245 incidental to operating computing resources 240. For example, associated components 245 could comprise heating units, cooling units, ventilation units, data center lighting, backup or redundant power supplies, or the like. Thus, data center 230 requires electricity 250 from power supply 260 to power computing resources 240 and associated components 245. Electricity 250 is generally measured in watts (W) or any multiple thereof [e.g., kilowatts (kW), megawatts (MW), or gigawatts (GW)]. The amount of electricity 250 required to power data center 230 depends on the aggregate demand from users 210, 212, 214 and 216, the energy intensity of each of their applications 220, 222, 224, and 226, and a variety of other factors (e.g., ambient temperature surrounding data center, downtime of the data center, energy efficiency of the applications, etc.).

Power supply 260 is provided electricity 250 from power source 270. Power source 270 includes any facility capable of providing electricity 250 to power supply 260. By way of example only and not limitation, power source 270 is a power plant, power station, or any similar facility that operates to generate electricity 250. To generate electricity 250, power source 270 could utilize fossil fuels, renewable energy technology, or some combination thereof. Fossil fuel-based power sources include any power source that utilizes fossil fuels (e.g., coal, natural gas, petroleum, or any other carbon-based fuel) to generate electricity 250. Renewable energy-based power sources include any power source that utilizes renewable natural resources, such as sunlight, wind, rain, tides, geothermal heat, or the like. Renewable energy-based power sources may also include power sources utilizing nuclear fission.

One key difference between fossil fuel-based power sources and renewable energy-based power sources is the amount of greenhouse gases emitted during the generation of electricity 250. Fossil fuel-based power sources generally emit a myriad of greenhouse gases during the generation of electricity 250, such as, for example, carbon dioxide, methane, trioxygen (ozone), nitrous oxide, or the like. On the other hand, renewable energy-based power sources generally emit little to no greenhouse gases during the generation of electricity 250. As such, entities consuming energy, such as data center 230 operating computing resources 240 and associated components 245, may consume electricity 250 generated by fossil fuel-based power supplies, renewable energy-based power supplies, or some combination of thereof.

The manner in which electricity 250 is produced, of course, has environmental significance. When an entity consumes energy generated as a result of emitting greenhouse gases, that entity is said to have a “carbon footprint.” A “carbon footprint” is a measure of the impact an activity has on the environment, generally measured in units of carbon dioxide (CO₂) or carbon dioxide equivalents (CDE) released into the atmosphere as a result of that activity.

Returning now to FIG. 2, based on the foregoing, it will be apparent to those of ordinary skill in the art that the carbon footprint of data center 230 depends both on the aggregate amount of electricity 250 consumed to operate data center 230 and the type of power source 270. By way of example, a high-demand data center utilizing energy supplied from a coal-fired power source would likely have a greater carbon footprint (likely measured in tons or pounds of carbon dioxide or CDE) than a low-demand data center utilizing solely renewable, non-carbon based power sources (e.g., wind farms).

Another result of running applications 220, 222, 224, and 226 on computing resources 240 is the need to consume large amounts of water 280. During the operation of a data center, water 280 is used in a variety of ways, including as a cooling fluid for heat dissipation. In FIG. 2, water 280 is supplied from a water source 285. Water source 285 can include, by way of example, any fresh water source (e.g., a river, a lake, etc.), any salt-water source (e.g., an ocean), or any upstream user or seller. The amount of water 280 needed for cooling varies with the amount of electricity 250 required to operate data center 230 (because water is primarily used to dissipate heat, which is a result of electricity consumption). For example, a data center in Eastern Oregon may draw fresh cooling water directly from a local river, such as the Columbia River. Using this fresh cooling water will result in the data center generating at least some waste water as effluent from the data center. Depending on the regulatory and legal framework of the jurisdiction where the data center operates, this waste water may be considered “industrial waste” rendering it unfit for any number of downstream uses (e.g., waste water cannot be used for crop irrigation or other secondary uses without clean-up and treatment). A different data center, operating in New Mexico, may use so-called “graywater” (water that had previously been used for other purposes at an upstream industrial plant). As a result of using “graywater.” the environmental impact of the hypothetical New Mexico data center, specifically the impact on fresh water supply, may be significantly different than the environmental impact of the hypothetical Oregon data center.

As those of ordinary skill of art will appreciate based upon the foregoing discussion, the hypothetical Oregon data center could have a relatively small carbon footprint (e.g., due to hydropower), but concurrently have a large fresh water footprint. In contrast, the hypothetical New Mexico data center could have a large carbon footprint (e.g., due to electricity generation), but also have no footprint as to fresh water. In the regard, each potential environmental impact of a data center, including a carbon and water footprint, is unique.

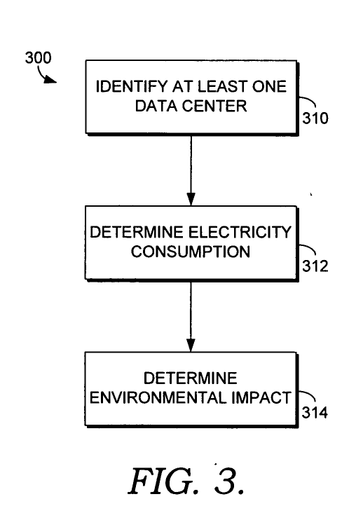

Turning to FIG. 3, a flow diagram is illustrated showing method 300 for calculating an environmental impact of a data center in accordance with an embodiment of the present invention. Method 300 discloses a general manner in which the various embodiments of the present invention may be employed. At block 310, at least one data center is identified. Next, at block 312, a total amount of electricity consumed to power the identified data center (or the aggregate electricity consumed to power a number of data centers) is determined. Determining electricity consumed to power the data center may, for example, include using information provided by a utility company or utility meter. Alternatively, actual or estimated electricity consumption may be determined by using commercially available software toolkits designed for data center operators that provide data center analytics or metrics (e.g., actual and critical electricity consumed, power usage efficiency, etc.). Alternatively, actual electricity consumption can be measured directly at the computing resource or application. Alternatively, any known method of estimating data center electricity consumption can be utilized as part of determining the electricity consumed to power the data center. For example and by no way as a means of limitation, estimating electricity consumption of a data center may include estimating or determining the number of applications at a data center (e.g., servers, virtual machines, storage, or bandwidth), multiplying the number of applications by a factor representing an estimated amount of electricity consumption per unit time for that type of application, and adjusting the estimated electricity consumption for any other known or ancillary factor (e.g., electricity consumed to power any associated component). Finally, for multiple data centers, block 312 could include any one of the above methods, either alone or in combination.

Referring again to FIG. 3, at block 314, an environmental impact of the data center is determined. For example, the total amount of carbon dioxide emitted to generate the electricity may be ascertained. In this example, the carbon footprint of a data center is based on the electricity consumption determined at block 312. Block 314 may include utilizing a national, regional, or industry-specific factor representative of carbon dioxide emissions per unit of electricity consumed. For example, a national factor representative of carbon dioxide emissions per unit of electricity consumed is readily ascertainable from publicly available materials. Alternatively, a national, regional, or industry-specific factor could be tailored to needs of a particular apportionment model. For example, block 314 could include isolating a geographic region (e.g., Florida, the northeast, etc.), determining the carbon dioxide and/or CDE emitted from that geographic region, determining the electricity consumed by that geographic region, and apportioning the amount of carbon dioxide and/or CDE emitted per unit of electricity consumed within that region. In an alternative embodiment, block 314 may include determining the total amount of water used by the data center.

Alternatively, block 314 may include utilizing data center-specific information to assess of the environmental impact of any data center or group of data centers. For example, block 314 may contemplate the manner in which electricity for a specific data center (e.g., electricity 250 of FIG. 2) was produced. As discussed with regard for FIG. 2, the manner in which electricity is generated can greatly affect the carbon footprint of a data center (e.g., fossil fuel-based versus renewable energy-based power supplies). For example, if a data center is powered solely by non-carbon-based electricity (e.g., nuclear fission, wind, hydroelectricity, etc.), the carbon footprint of that data center for electricity consumption would likely be less than the carbon footprint of a data center using fossil fuel-based electricity. As such, applying a known or derived national, regional or industry-specific factor would fail to accurately reflect the amount of carbon dioxide or carbon dioxide equivalents emitted to supply this data center with electricity. However, applying a national, regional, or industry-specific factor would provide a meaningful comparison between expected and actual data center carbon footprints, as discussed more fully below. Similarly, the source of the water may vary from data center to data center, thereby necessitating the use of data center specific information.

As would be apparent to those of skill in the art, the result of method 300 is a known carbon footprint of an identified data center or data centers. Utilizing this known carbon footprint is addressed further in the various embodiments described below.

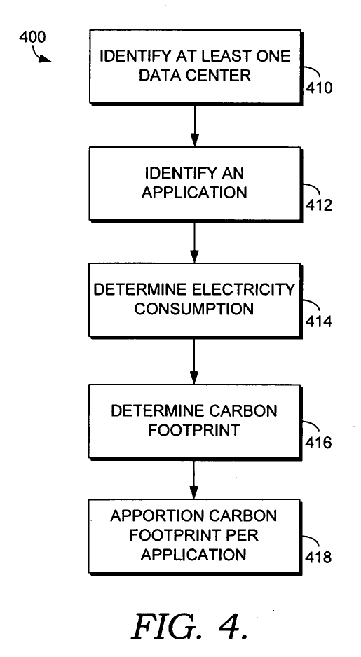

Having now discussed a general method for determining the carbon footprint of data centers, we now turn to FIG. 4. FIG. 4 illustrates a flow diagram showing a method 400 for apportioning carbon dioxide usage at a data center in accordance with an embodiment of the present invention. At block 410, as with block 310 of FIG. 3, at least one data center is identified. After identifying at least one data center, at block 412, an application is identified. In identifying an application, block 412 contemplates the desired analytic, the required confidence level of the desired analytic, the ability to interpret the analytic, the complexity of the apportionment process (see block 418, below), and the like. For example, if a data center wanted to determine the carbon footprint that resulted from its data storage services, an appropriate application could include storage, wherein the ultimate analytic could be expressed in pounds (or tons) carbon dioxide or carbon dioxide equivalents emitted per gigabyte storage capacity (or byte, kilobyte, megabyte, etc). Alternatively, if a data center wanted to determine the carbon footprint that resulted from its web hosting or communication services, the appropriate application could include bandwidth (demonstrating an amount of carbon emissions per unit of bandwidth per unit of time). Of course, the selection process could be dictated by consumer demand (e.g., data center customer desiring to know carbon emissions associated with its purchase). As stated above, the selected application may comprise any service or product that requires the consumption of electricity generally offered for sale by a data center. Applications include, for example only, servers, virtual machines, storage, and/or bandwidth.

At block 414, a total amount of electricity consumed at the data center or data centers is determined. Various methods may be used to determine electricity consumption of a data center, such as, for instance, those methods discussed with reference to block 312 of FIG. 3. At block 416, a total amount of carbon dioxide emitted to generate the electricity consumed by the data center is determined. That is, the carbon footprint of the data center or data centers is determined. Various methods may be used to determine a carbon footprint, such as, for instance, those methods discussed with reference to block 314 of FIG. 3.

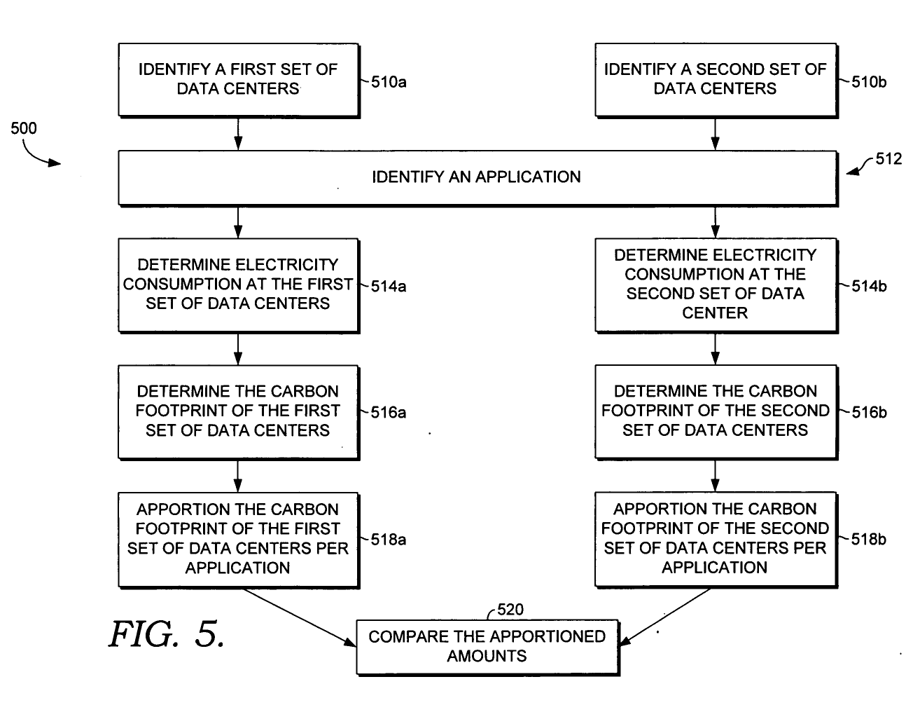

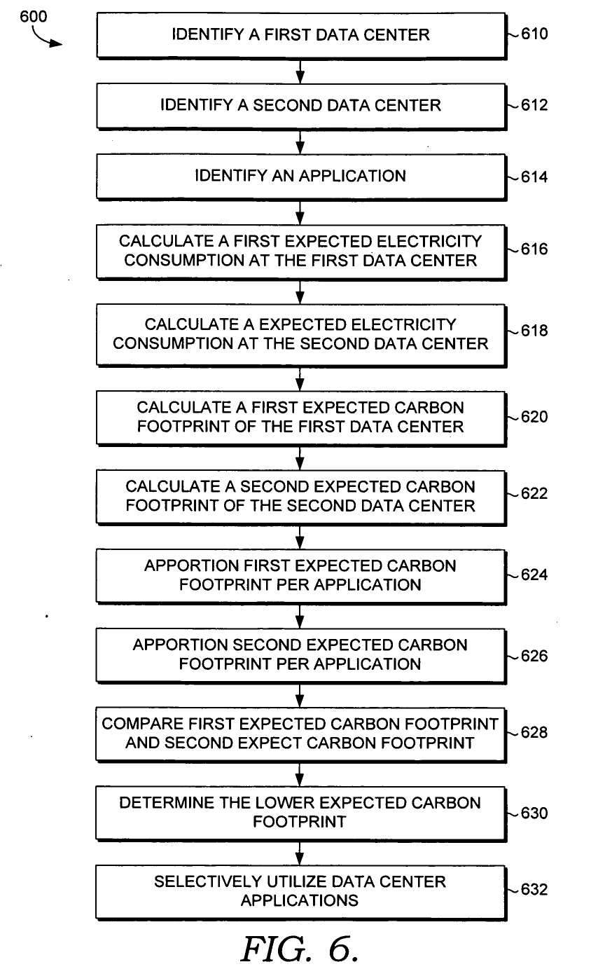

At block 418, an apportioned amount of carbon dioxide emitted per application is determined. Restated, the carbon footprint determined at block 416 is apportioned on the basis of the application selected at block 412. The process comprising block 418, namely, apportioning the carbon footprint on a per application basis, is relevant to other embodiments hereinafter addressed. As such, this detailed discussion of block 418 may apply equally to block 418 of FIG. 4, block 518a and block 518b of FIG. 5, and blocks 624 and 626 of FIG. 6.

If the application selected at block 412 is a server, block 418 may include determining the total number of contributing servers at the data center or data centers and apportioning each contributing server a proportional share of the carbon footprint determined at block 416. The term “contributing” servers includes all servers that contributed at least partially to the carbon footprint determined at block 416. Generally, contributing servers will include only those servers that consumed electricity at the data center or data centers identified at block 410. Thus, for example, contributing servers would not likely include servers that are present at the data center but did not consume any electricity (e.g., powered off, disabled, emergency back-up). Alternatively, the number of contributing servers may optionally include any servers dedicated to operating the data center (e.g., servers utilized to service data center computing resources). In this embodiment, the carbon dioxide and carbon dioxide equivalent emissions contributed by servers dedicated to the data center would be apportioned to the data center itself (as the “user” of the servers). On the other hand, the data center could optionally exclude the number of servers dedicated to the operation of the data center from the apportionment process entirely (thereby decreasing the total number of contributing servers and increasing the footprint attributable to each individual contributing server). This would result in the carbon footprint associated with operating the data center being passed along to the data center users (i.e., a carbon premium passed on to the ultimate consumer). Those skilled in the art will now recognize, that after completing block 418 of method 400 where the application selected at block 412 is a server, each contributing server will have an apportioned amount of carbon dioxide emitted.

Referring again to block 418, if the application selected at block 412 is a virtual machine, block 418 may include determining the total number of virtual machines at the data center and apportioning each virtual machine a proportional share of the carbon footprint determined at block 416. In an embodiment, apportioning carbon footprint for virtual machines may essentially be equivalent to apportionment for servers. As such, the various considerations addressed with regard to apportioning for servers apply equally to this embodiment. As with the apportionment process for servers, any virtual machines dedicated to the operation of the data center or data centers may optionally be excluded for the apportionment process. Those skilled in the art will now recognize that, after completing block 418 of method 400 where the application selected at block 412 is a virtual machine, each virtual machine will have an apportioned amount carbon dioxide emitted.

Returning to block step 418, if the application selected at block 412 is an amount of storage, block 418 may include determining the total amount of contributing storage at the data center or data centers and apportioning each unit of contributing storage a proportional share of the carbon footprint determined at block 416. Here, the term “total amount of contributing storage” includes all storage that contributed at least partially to the carbon footprint determined at block 416. Generally, contributing storage will include only that amount of storage that consumed electricity at the data center or data centers identified at block 410. Thus, for example, contributing storage would not likely include any storage that was present at the data center, but are for some did not consume any electricity (i.e., portable media, powered off, disabled, emergency back-up). Further, contributing storage may optionally exclude storage that was unused during the period of time under examination by method 400, but otherwise consumed electricity. Still further, contributing storage may optionally include any storage dedicated to the operation of the data center (e.g., storage used to store data for the data center). Thus, the contributing storage may optionally include the raw storage ability of the data center, the actual amount of data stored in data center storage, the raw storage ability of the data center less any storage utilized for data center operations, the actual amount of data stored in the data center storage less any storage utilized for data center operations, or any other desired quantity of storage. Those skilled in the art will now recognize, that after completing block 418 of method 400 where the application selected at block 412 is an amount of storage, each unit of contributing storage will have an apportioned amount of carbon dioxide emitted.

Again referring to block step 418, if the application selected at block 412 is an amount of bandwidth, block 418 may include determining the adjusted amount of bandwidth at the data center or data centers and apportioning each unit of adjusted bandwidth a proportional share of the carbon footprint determined at block 416. Bandwidth, as the term is used herein, represents the capacity of the data center to transfer data through a medium (e.g., wireless) or over a physical connection (e.g., wires). Bandwidth is generally measured in bits per second or some multiple thereof (e.g., gigabits per second, gigabytes per hour, etc.). First, the total amount of bandwidth available from the identified data center or data centers is determined. Next, the total amount of data center utilized bandwidth is determined. Data center utilized bandwidth includes that amount of bandwidth that is dedicated to operation of the identified data center. For example, bandwidth used by the data center for a data center-required storage account or virtual machine could comprise the amount of data center utilized bandwidth. With these two bandwidth totals determined, an adjusted amount of bandwidth is calculated. The adjusted amount of bandwidth is the difference between the total amount of bandwidth available from the data center and the data center utilized bandwidth. For example, if a data center has 75 total gigabytes of available bandwidth, but 100 megabytes of bandwidth is used to operate the data center, the adjusted amount of bandwidth would be about 74.9023 gigabytes of bandwidth (assuming 1024 megabytes in a gigabyte).

After determining the adjusted amount of bandwidth, the amount of electricity consumed by the adjusted amount of bandwidth is determined. Any method previously identified with regard to step 312 of FIG. 3 is suitable for this step. However, it is contemplated that the amount of total electricity consumed by the data center may be decreased by the percentage of bandwidth dedicated to the data center. For example, if 10% of the total amount of bandwidth is also data center utilized bandwidth, then the electricity required to provide the adjusted amount of bandwidth could simply equal 90% of the electricity required to provide the total amount of bandwidth (i.e., 90% of the total electricity consumption determined at block 414). The amount of electricity required to provide the adjusted amount of bandwidth is then converted into a carbon footprint, for instance, using methods previously identified at block 314 of FIG. 3. Finally, a proportional share of the data center carbon footprint attributable to the adjusted bandwidth is then apportioned to each unit of the adjusted amount of bandwidth. Those skilled in the art will now recognize, that after completing block 418 of method 400 where the application selected at block 412 is an amount of bandwidth, each unit of the adjusted amount of bandwidth will have an apportioned amount of carbon dioxide emitted.

As those skilled in the art would recognize, the contemplated apportionment process at block 418 can optionally include or optionally exclude a temporal dimension. For example, in one embodiment of the present invention, the carbon footprint identified at block 416 may optionally be expressed in tons of total carbon dioxide or carbon dioxide equivalents emitted. Alternatively, the carbon footprint identified at block 416 may optionally be expressed in tons of carbon dioxide or carbon dioxide equivalents emitted per some unit of time (e.g., an hour, a week, a month, a year, the expected life of the data center, etc.). Of course, desired analytics may dictate whether a temporal dimension is incorporated into method 400.

Turning now to FIG. 5, a flow diagram is provided that shows a method 500 for assessing relative carbon dioxide emissions at a data center in accordance with an embodiment of the present invention. Turning first to blocks 510a and 510b, a first set and a second set of data centers are identified. The first set and/or the second set of data centers may optionally include only a single data center. The data centers identified as the first set of data centers at block 510 are commonly owned or commonly operated data centers. Any data center within the second set of data centers identified at block 510b may be commonly owned or commonly operated with other data center within the second set of data centers. By virtue of this disclosed scheme of common ownership or common operation, the carbon footprint analytics of the first set of data centers may be compared against a homogeneous (e.g., data centers commonly owned or operated by a competitor, data centers within a specific region or geography, etc.) or heterogeneous (e.g., national trends for data centers) sample of other data centers.

Referring again to method 500 at block 512, an application is identified for both the first set of data centers and the second set of data centers. The application identification process of block 512 has been previously disclosed at block 412 of FIG. 4. Continuing to blocks 514a and 514b, the amount of electricity consumed at the first set of data centers and the amount of electricity consumed at the second set of data centers is calculated. The various methods for calculating the actual and/or estimated electricity consumption of blocks 514a and 514b have been previously disclosed at block 312 of FIG. 3. At blocks 516a and 516b, the amount of carbon dioxide emitted at the first set of data centers and the second set of data centers is determined. The numerous methods for making the determinations of blocks 516a and 516b have been disclosed at block 314 of FIG. 3. One significant aspect of the present embodiment is that the second group of data centers are not commonly owned or commonly operated with any data center of the first set of data centers. As such, it is contemplated that block 516b will utilize a national, regional or industry-specific factor representative of carbon dioxide emissions per unit of electricity consumed.

At blocks 518a and 518b, the amount of carbon dioxide emitted by each of the first set of data centers and the second set of data centers, determined at blocks 516a and 516b, is apportioned on the basis of the application selected at block 512. As such, completion of blocks 518a and 518b results in a first apportioned amount of carbon dioxide emitted and a second apportion amount of carbon dioxide emitted. The various methods, techniques, and considerations relevant to blocks 518a and 518b have been previously addressed at block 418 of FIG. 4.

Finally, at block 520 of method 500, the first apportioned amount of carbon dioxide emitted and the second apportioned amount of carbon dioxide emitted are compared. It is contemplated that the comparison of block 520 will comprise a graphical, a numerical, and/or an auditory comparison. Utilizing the comparison at block 520, strategic decision-making, such as, for example, selectively pricing applications at data centers with a relatively lower carbon footprint, selectively pricing applications at data centers with a relatively greater carbon footprint, selectively utilizing existing applications or new applications to reduce or increase the carbon footprint of a data center, or the like

Turning to FIG. 6, a flow diagram is illustrated showing method 600 for selectively utilizing data center applications to minimize a carbon footprint in accordance with an embodiment of the present invention. As is evident to those of skill of in the art, the previous disclosures regarding FIG. 2, FIG. 3, FIG. 4, and FIG. 5 may equally be applicable to the disclosed embodiment represented as FIG. 6. Specifically, blocks 610 and 612 comprise identifying a first data center and a second data center. This process was previously addressed at block 310 of FIG. 3. At block 614, method 600 comprises identifying an application, which was previously addressed at block 412 of FIG. 4. Continuing, blocks 616 and 618 comprise calculating an expected amount of electricity consumption at both the first data center and the second data center. The methods of estimating electricity consumption of a data center have been previously disclosed at block 312 of FIG. 3. At blocks 620 and 622, an expected first amount of carbon dioxide emitted and an expected second amount of carbon dioxide emitted are determined. The methods of converting electricity consumption into a carbon footprint were discussed above at block 314 of FIG. 3. At blocks 624 and 626, an expected first apportioned amount carbon dioxide emitted per application and an expected second apportioned amount carbon dioxide emitted per application are determined. The methods of determining an apportioned amount of a carbon footprint were previously disclosed at block 418 of FIG. 4. At block 628 of method 600, the expected first apportioned amount and expected second apportioned amount of carbon dioxide emitted are compared. The methods of comparing apportioned amounts have been previously disclosed at block 520 of FIG. 5. In each of the foregoing blocks, the initial disclosure is herein incorporated by reference into this discussion of FIG. 6 and method 600.

At block 630, the lower expected carbon footprint is determined by identifying the data center whose application usage will result in a lower expected carbon footprint. Finally, block 632 comprises selectively utilizing the data center application whose usage will result in a lower expected carbon footprint. It is contemplated that the selective utilization of block 632 will be implemented as part or all of a software system stored as executable instructions on a computer-readable storage media. Of course, however, it is understood that the selected utilization of block 632 need not be performed as part of any software system or automated program. On the contrary, any manner of selectively utilizing data center resources is acceptable.

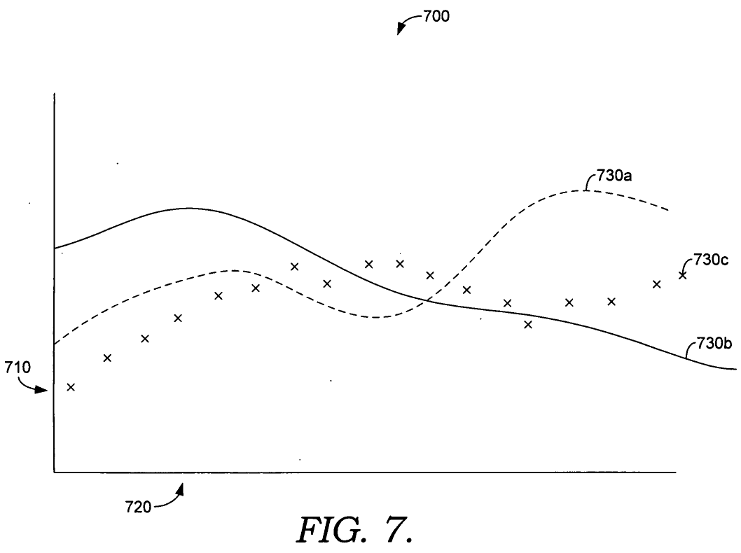

Referring now to FIG. 7, a chart is illustrated showing a graphical comparison 700 for comparing data center analytics in accordance with an embodiment of the present invention. Graphical comparison 700 includes a vertical axis 710 and a horizontal axis 720. Vertical axis 710 may represent any analytic that is capable of comparison. By way of example, vertical axis 710 may represent an amount of carbon dioxide emitted as a result of a particular application, a cumulative amount of carbon dioxide emitted over a selected period of time, or the like. Horizontal axis 720 may also represent any analytic that is capable of comparison. For instance, horizontal axis 720 may represent a temporal dimension (e.g., hours, days, weeks, months, or the like), an amount of an application, or the like. Vertical axis 710 and horizontal axis 720 intersect to create a plane, on which a number of data lines 730a, 730b, and 730c may be depicted. Data lines 730a, 730b, and 730c each may represent any desired analytic of a data center or set of data centers. For example, 730a may optionally represent the carbon dioxide emissions per unit of contributing storage at a first data center. Further, 730b may optionally represent the carbon dioxide emissions per unit of contributing storage at a first set of data centers. Still further, 730c may optionally represent the carbon dioxide emissions per unit of contributing storage at a second set of data centers. It would be apparent to those of skill in the art that the analytic represented by data lines 730a, 730b, and 730c may depend on the information incorporated into vertical axis 710 and the horizontal axis 720. Moreover, any analytic capable of comparison can be portrayed on either the vertical axis 710 or horizontal axis 720. It would also be apparent to those of skill in the art that graphical comparison may optionally include or exclude additional data lines and/or an additional axis.

### SPECIFIC EXAMPLES

As described above, examples of various embodiments of the present invention may include systems, methods, and computer-readable media that determine and apportion the carbon dioxide emissions of a data center. The various features of the present invention have been described in relation to various embodiments, which are intended in all respects to be illustrative rather than restrictive. Alternative embodiments will become apparent to those of ordinary skill in the art to which the present invention pertains without departing from its scope.

In general, methods according to at least some embodiments of this invention include: (a) determining a carbon footprint of a data center or a set of data centers; (b) apportioning a carbon footprint of a data center or set of data centers on a per application basis; (c) comparing an apportioned carbon footprint; and (d) selectively utilizing data center resources to manage a carbon footprint.

The following tables provide an even more concrete example of carbon footprint apportionment that may be used in accordance with at least one embodiment of this invention. A list of potential data centers analytics may look as follows:

| Amount | Amount of: |
|---|---|
| 1,000 | Killowatts Electricity Consumed |
| 5,000 | Pounds of Carbon Attributable to Electricity Consumed |
| 100 | Number of Contributing Servers |
| 500 | Number of Virtual Machines |
| 100 | Gigabytes of Contributing Memory |
| 50 | Gigabytes of Total Bandwidth |
| 10 | Gigabytes of Data Center Utilized Bandwidth |
| 50.00 | Pounds of Carbon Per Contributing Server |
| 10.00 | Pounds of Carbon Per Virtual Machine |
| 1.00 | Pounds of Carbon Per Gigabyte of Contributing Memory |
| 125.00 | Pounds of Carbon Per Gigabyte of Adjusted Bandwidth |

In the first row, a potential amount of electricity consumption will be determined. The methods discussed with reference to block 312 of FIG. 3 will be useful in determining this potential amount of electricity consumed. In the second row, a potential amount of pounds of carbon attributable to the electricity consumed will be determined. The methods discussed with reference to block 314 of FIG. 3 will be useful in determining this potential amount. The next five rows, specifically the rows having a number of contributing servers, a number of virtual machines, a number of gigabytes of contributing storage, an amount of total bandwidth, and an amount of data center utilized bandwidth, each will provide one or more of the necessary analytics that will aid in practicing various embodiments of the present invention. The final four rows each recite the data center analytics on a per application basis, as addressed at block 418 of FIG. 4.

A second list of potential data centers analytics may look as follows:

| Amount | Amount of: |
|---|---|
| 5,000 | Killowatts Electricity Consumed |
| 2,500 | Pounds of Carbon Attributable to Electricity Consumed |
| 200 | Number of Contributing Servers |
| 300 | Number of Virtual Machines |
| 75 | Gigabytes of Contributing Memory |
| 25 | Gigabytes of Total Bandwidth |
| 12 | Gigabytes of Data Center Utilized Bandwidth |
| 12.50 | Pounds of Carbon Per Contributing Server |
| 8.33 | Pounds of Carbon Per Virtual Machine |
| 2.67 | Pounds of Carbon Per Gigabyte of Contributing Memory |
| 131.58 | Pounds of Carbon Per Gigabyte of Adjusted Bandwidth |

Again in the first row, a potential amount of electricity consumption will be determined. The methods discussed with reference to block 312 of FIG. 3 will be useful in determining this potential amount of electricity consumed. In the second row, a potential amount of pounds of carbon attributable to the electricity consumed will be determined. The methods discussed with reference to block 314 of FIG. 3 will be useful in determining this potential amount. The next five rows, specifically the rows having a number of contributing servers, a number of virtual machines, a number of gigabytes of contributing storage, an amount of total bandwidth, and an amount of data center utilized bandwidth, each will provide one or more of the necessary analytics that will aid in practicing various embodiments of the present invention. The final four rows each recite the data center analytics on a per application basis, as addressed at block 418 of FIG. 4.

With reference to these potential lists, other embodiments of the present invention may be realized. For example, if the first list provided was for a first data center and the second list provided was for a second data center, the lists could be compared in accordance with one embodiment of the present invention. Moreover, depending on the application selected, either the first data center or second data center might have a lower carbon footprint associated with a specific data center application. For example, under these hypothetical values, the first data will have a lower carbon footprint per server, but have a higher carbon footprint per unit of adjusted bandwidth. Those of ordinary skill in the art would readily appreciate how such a discrepancy will exist, such as, for example, aging computing resources at a data center, the manner in which electricity was generated and/or consumed, the amount of resources dedicated to operating the data center, or the like.

In addition to comparing the potential lists, other embodiments of the present invention may still further be realized. These potential lists may optionally be used to selectively utilize data center resources so as to adjust a carbon footprint of a consumer or client. For example, where a client demands a server application, the first data center application may optionally be selected. However, where a client demands an amount of bandwidth, the second data center application may optionally be selected. Moreover, utilizing this information will permit a discriminatory pricing scheme so as to encourage or discourage selected applications at selected data centers. For example, the server applications of the first data center may optionally be priced higher than the server application of the second data center. Alternatively, the information may be utilized to effectively barter “cap and trade” carbon credits. For example, carbon credits could be efficiently allocated by private actors in accordance with an embodiment of the invention. Any other manner for utilizing the resultant analytics is also contemplated.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims. For example, although the discussion throughout a majority of the specification relates to apportioning a carbon footprint, embodiments of the present invention are not so limited. On the contrary, any environmental factor, including water consumption, is contemplated as being within the scope of embodiments of the present invention.

What is claimed is:

1. One or more computer-readable storage media embodying computer useable instructions for performing a method of apportioning an environmental impact of a data center, said method comprising:
identifying at least one data center and an application, wherein said application is selected from a group consisting of a server, a virtual machine, an amount of storage, and an amount of bandwidth;
calculating a total amount of electricity consumed by said at least one data center;
calculating an environmental impact of said at least one data center; and
determining an apportioned amount of the environmental impact per said application.

2. The computer-readable storage media of claim 1, wherein said environmental impact comprises an amount of carbon dioxide emitted as a result of generation of said total amount of electricity consumed by said at least one data center and an amount of water consumed as a result of using said total amount of electricity consumed by said at least one data center.

3. The computer-readable storage media of claim 2, wherein said application comprises a server, and determining the apportioned amount of carbon dioxide emitted per said application further comprises:
determining a total number of contributing servers at said at least one data center; and
calculating an apportioned amount of carbon dioxide emitted per said total amount of contributing servers by apportioning said total amount of carbon dioxide emitted as a result of generation of said total amount of electricity consumed at said data center to each of said total number of contributing servers.

4. The computer-readable storage media of claim 2, wherein said application comprises a virtual machine, and determining the apportioned amount of carbon dioxide emitted per said application further comprises:
determining a total number of virtual machines at said at least one data center; and
calculating an apportioned amount of carbon dioxide emitted per said total number of virtual machines by apportioning said total amount of carbon dioxide emitted as a result of generation of said total amount of electricity consumed at said data center to each of said total number of virtual machines.

5. The computer-readable storage media of claim 2, wherein said application comprises an amount of storage, and determining the apportioned amount of carbon dioxide emitted per said application further comprises:
determining a total amount of contributing storage at said at least one data center;
calculating an apportioned amount of carbon dioxide emitted per a unit of contributing storage by apportioning said amount of carbon dioxide emitted as a result of generation of said total amount of electricity at said data center to each of said units of contributing storage at said at least one data center.

6. The computer-readable storage media of claim 2, wherein said application comprises an amount of bandwidth, and determining the apportioned amount of carbon dioxide emitted per said application further comprises:
determining a total amount of bandwidth available at said at least one data center;
determining a total amount of data center utilized bandwidth;
determining an adjusted amount bandwidth at said at least one data center;
determining a total amount of electricity consumed to provide said adjusted amount of bandwidth at said at least one data center;
determining a total amount of carbon dioxide emitted as a result of generation of said total amount of electricity consumed to provide said adjusted amount of bandwidth at said at least one data center; and
calculating an apportioned amount of carbon dioxide emitted per said adjusted amount of bandwidth by apportioning said amount of carbon dioxide emitted as a result of generation of said total amount of electricity consumed to provide said adjusted amount of bandwidth at said at least one data center to said adjusted amount of bandwidth at said at least one data center.

7. The computer-readable storage media of claim 2, wherein said amount of electricity consumed at said at least one data center further includes electricity consumption associated with heating, cooling, and/or ventilating said data center.

8. A method of assessing relative carbon dioxide usage at a data center, said method comprising:
(a) identifying a first plurality of data centers, a second plurality of data centers, and an application, wherein said first plurality of data centers are commonly owned or commonly operated;
(b) calculating a first total amount of electricity consumed at said first plurality data centers and a second total amount of electricity consumed at said second plurality data centers;
(c) calculating a first total amount of carbon dioxide emitted as a result of generation of said first total amount of electricity consumed at said first plurality of data centers and calculating a second total amount of carbon dioxide emitted as a result of generation of said second total amount of electricity consumed at said second plurality data centers, wherein calculating said second total amount of carbon dioxide emitted as a result of generation of said second total amount of electricity consumed at said second plurality data centers comprises utilizing national, regional or industry averages representative of carbon dioxide emissions per unit of electricity consumed;
(d) determining a first apportioned amount of carbon dioxide emitted as a result of generation of said first total amount of electricity consumed at said first plurality of data centers per said application;
(e) determining a second apportioned amount of carbon dioxide emitted as a result of generation of said second total amount of electricity at said second plurality of data centers per said application; and
(f) comparing said first apportioned amount of carbon dioxide emitted to said second apportioned amount of carbon dioxide emitted.

9. The method of claim 7, wherein step (f) further comprises a graphical, a numerical, and/or an auditory comparison of said first total amount of carbon dioxide emitted and said second total amount of carbon dioxide emitted.

10. The method of claim 8, further comprising:
(g) based upon comparison step (f), adjusting a price of said application at a data center within the first plurality of data centers.

11. The method of claim 7, wherein the second plurality of data centers includes no data center that is commonly owned or operated with any data center within the first plurality of data centers.

12. The method of claim 7, wherein said first total amount of electricity consumed at said first plurality data centers and said second total amount of electricity consumed at said second plurality data centers further include electricity consumption associated with heating, cooling, and/or ventilating, said first plurality of data centers and said second plurality of data centers.

13. The method of claim 7, wherein said application is selected from the group consisting of a server, a virtual machine, an amount of storage, and a bandwidth.

14. One or more computer-readable storage media embodying computer useable instructions for performing a method of prospectively minimizing data center-related carbon dioxide emissions, said method comprising:
identifying a first data center;
identifying a second data center;
identifying an application;
calculating an expected first amount of electricity consumption at said first data center;
calculating an expected second amount of electricity consumption at said second data center;
calculating an expected first amount of carbon dioxide emitted as a result of the generation of said expected first amount of electricity consumption;
calculating an expected second amount of carbon dioxide emitted as a result of the generation of said expected second amount of electricity consumption;
determining an expected first apportioned amount of said expected first amount of carbon dioxide;
determining an expected second apportioned amount of said expected second amount of carbon dioxide;
comparing said expected first apportioned amount to said expected second apportioned amount;
determining whether said expected first apportioned amount or said expected second apportioned amount has a lower expected amount of carbon dioxide emission; and
selectively utilizing said application at a data center determined to have the lower expected amount of carbon dioxide emitted.

15. The computer-readable storage media of claim 13, wherein said first data center comprises a first plurality of data centers and said second data center comprises a second plurality of data centers.

16. The computer-readable storage media of claim 13, wherein said plurality of data centers are commonly owned or commonly operated.

17. The computer-readable storage media of claim 13, wherein calculating said expected second amount of carbon dioxide emitted as a result of the generation of said expected second amount of electricity consumption comprises utilizing national, regional or industry-specific factor representative of carbon dioxide emissions per unit of electricity consumption.

18. The computer-readable storage media of claim 13, wherein said expected first amount of electricity consumption at said first data center and said expected second amount of electricity consumption at said second data center further include electricity consumption associated with heating, cooling, and/or ventilating, said first and second data centers.

19. The computer-readable storage media of claim 13, wherein said per application is selected from the group consisting of a server, a virtual machine, an amount of storage, and a bandwidth.

20. The computer-readable storage media of claim 13, wherein an application price at said first data center is adjusted in response to said expected first apportioned amount.
